(19) United States
(12) Patent Application Publication
(10) Pub. No.: US 2025/0018771 A1
(43) Pub. Date: Jan. 16, 2025

(54) VEHICULAR REFRIGERATION CYCLE UNIT AND VEHICULAR AIR CONDITIONING DEVICE

(71) Applicant: MITSUBISHI HEAVY INDUSTRIES THERMAL SYSTEMS, LTD., Tokyo (JP)

(72) Inventors: Masatoshi MORISHITA, Tokyo (JP); Takayuki KOBAYASHI, Tokyo (JP); Nobuya NAKAGAWA, Tokyo (JP); Katsuhiro SAITO, Tokyo (JP); Hideto NOYAMA, Tokyo (JP); Hirotaka TANABE, Tokyo (JP); Hirofumi HIRATA, Tokyo (JP); Shinya HAMAMOTO, Tokyo (JP)

(73) Assignee: MITSUBISHI HEAVY INDUSTRIES THERMAL SYSTEMS, LTD., Tokyo (JP)

(21) Appl. No.: 18/706,142

(22) PCT Filed: Nov. 4, 2021
(86) PCT No.: PCT/JP2021/040610

§ 371 Date: Apr. 30, 2024

(51) Int. Cl. B60H 1/32

(52) U.S. Cl. CPC B60H 1/3227; B60H 1/3223; B60H 1/3228

(57) ABSTRACT

Provided is a vehicular refrigeration cycle unit interposed between a vehicle-exterior heat exchanger and a vehicle-interior heat exchanger and that exchanges heat between secondary refrigerants flowing through the vehicle-exterior heat exchanger and the vehicle-interior heat exchanger, respectively, the vehicular refrigeration cycle unit being provided with a refrigeration cycle including a compressor, a condenser, an expansion valve, and an evaporator through which a primary refrigerant sequentially flows, and the distance between the compressor and the evaporator is longer than the distance between the compressor and the condenser.

### TECHNICAL FIELD

The present disclosure relates to a vehicular refrigeration cycle unit and a vehicular air conditioning device.

### BACKGROUND ART

Patent Document 1 discloses a refrigeration cycle constituting a vehicular heat management system and including a compressor, a heat medium cooler (evaporator), and a heat medium heater (condenser) accommodated in a case having thermal insulating properties.

### CITATION LIST

### Patent Literature

Patent Document 1: JP 2014-201224 A

### SUMMARY OF INVENTION

### Technical Problem

The compressor described in Patent Document 1 compresses a refrigerant flowing through the vehicular heat management system, and thus the temperature of the compressor is higher than that of other devices. Since the compressor is disposed adjacent to the evaporator with a part of the case interposed therebetween, the compressor transfers heat more preferentially to the evaporator than to the condenser. Therefore, there is a problem that an increase in the temperature of the evaporator by the compressor is higher than an increase in the temperature of the condenser by the compressor. When the temperature of the evaporator increases, the heat exchange performance of the evaporator decreases.

The present disclosure has been made to solve the above-described problem, and an object thereof is to provide a vehicular refrigeration cycle unit and a vehicular air conditioning device that can suppress a decrease in a heat exchange efficiency of an evaporator.

### Solution to Problem

To solve the above-described problem, a vehicular refrigeration cycle unit according to the present disclosure is a vehicular refrigeration cycle unit interposed between a vehicle-exterior heat exchanger and a vehicle-interior heat exchanger and being configured to exchange heat between respective secondary refrigerants flowing through the vehicle-exterior heat exchanger and the vehicle-interior heat exchanger. The vehicular refrigeration cycle unit is provided with a refrigeration cycle including a compressor, a condenser, an expansion valve, and an evaporator through which a primary refrigerant sequentially flows. A distance between the compressor and the evaporator is longer than a distance between the compressor and the condenser.

Further, a vehicular refrigeration cycle unit according to the present disclosure is a vehicular refrigeration cycle unit which is interposed between a vehicle-exterior heat exchanger and a vehicle-interior heat exchanger and exchanges heat between respective secondary refrigerants flowing through the vehicle-exterior heat exchanger and the vehicle-interior heat exchanger. The vehicular refrigeration cycle unit is provided with a refrigeration cycle including a compressor, a condenser, an expansion valve, and an evaporator through which a primary refrigerant sequentially flows. A distance between a discharge port for the primary refrigerant at the compressor and the evaporator is longer than a distance between the discharge port and the condenser.

Furthermore, a vehicular refrigeration cycle unit according to the present disclosure is a vehicular refrigeration cycle unit which is interposed between a vehicle-exterior heat exchanger and a vehicle-interior heat exchanger and exchanges heat between respective secondary refrigerants flowing through the vehicle-exterior heat exchanger and the vehicle-interior heat exchanger. The vehicular refrigeration cycle unit is provided with a refrigeration cycle including a compressor, a condenser, an expansion valve, and an evaporator through which a primary refrigerant sequentially flows. A length of a pipe connecting the compressor and the evaporator is longer than a length of a pipe connecting the compressor and the condenser.

A vehicular air conditioning device according to the present disclosure includes the vehicular refrigeration cycle unit, the vehicle-exterior heat exchanger, and the vehicle-interior heat exchanger.

### Advantageous Effects of Invention

According to the present disclosure, it is possible to provide a vehicular refrigeration cycle unit and a vehicular air conditioning device that can suppress a decrease in a heat exchange efficiency of an evaporator.

### BRIEF DESCRIPTION OF DRAWINGS

FIG. 1 is a system diagram illustrating a configuration of a vehicular air conditioning device (during a heating operation) according to an embodiment.

FIG. 2 is a plan view of a vehicular refrigeration cycle unit according to a first embodiment.

FIG. 3 is a plan view of a vehicular refrigeration cycle unit according to a second embodiment.

FIG. 4 is a plan view of a vehicular refrigeration cycle unit according to a third embodiment.

FIG. 5 is a plan view of a vehicular refrigeration cycle unit according to a fourth embodiment.

FIG. 6 is a plan view of a vehicular refrigeration cycle unit according to a fifth embodiment.

FIG. 7 is a system diagram illustrating a configuration of a vehicular air conditioning device (during cooling operation) according to an embodiment.

FIG. 8 is a plan view of a vehicular refrigeration cycle unit according to another embodiment.

### DESCRIPTION OF EMBODIMENTS

Hereinafter, a vehicular air conditioning device according to an embodiment of the present disclosure will be described with reference to the drawings.

### First Embodiment

### Vehicular Air Conditioning Device

A vehicular air conditioning device is a device that is installed in an electric vehicle or the like and that conditions air in a vehicle body. A difference in temperature between the inside and the outside of the vehicle body is regulated by the vehicular air conditioning device. In the present embodiment, a configuration in which the vehicular air conditioning device performs a heating operation will be described as an example.

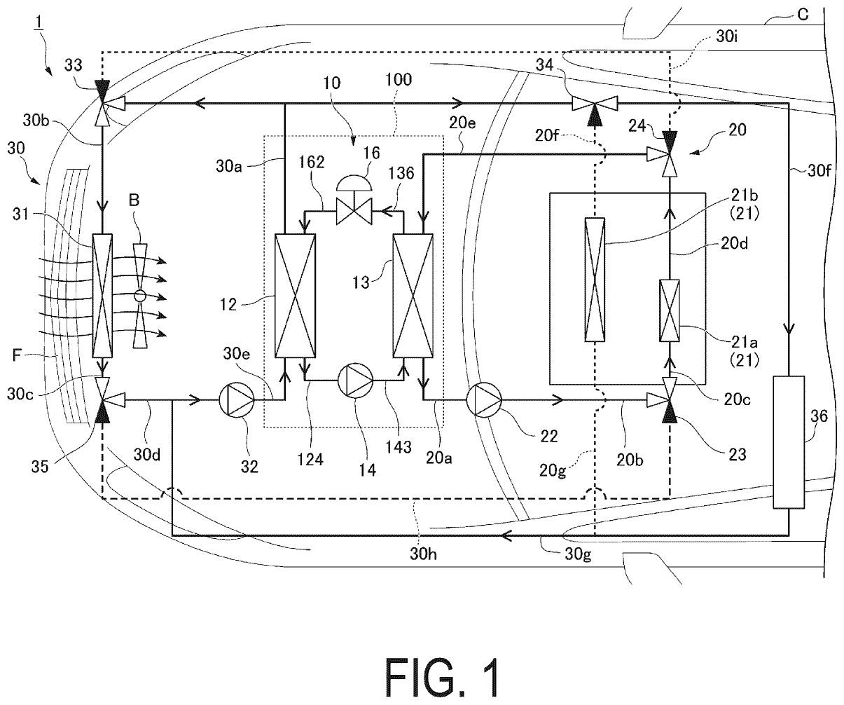

As illustrated in FIG. 1, a vehicular air conditioning device 1 includes a vehicular refrigeration cycle unit 100, a vehicle-interior heat medium circuit 20, and a vehicle-exterior heat medium circuit 30.

In the drawings, among various lines (pipes) included in the vehicular refrigeration cycle unit 100, the vehicle-interior heat medium circuit 20, and the vehicle-exterior heat medium circuit 30, lines in an open state through which a refrigerant can flow are indicated by solid lines, and lines in a closed state through which a refrigerant cannot flow are indicated by broken lines. In addition, among various valves, valves in black indicate a closed state, and valves in white indicate an open state.

### Vehicular Refrigeration Cycle Unit

The vehicular refrigeration cycle unit 100 is a device for circulating a primary refrigerant that exchanges heat with a secondary refrigerant used for in-vehicle air conditioning. As the primary refrigerant in the present embodiment, for example, an R290 refrigerant (propane) which is a highly flammable hydrocarbon is used.

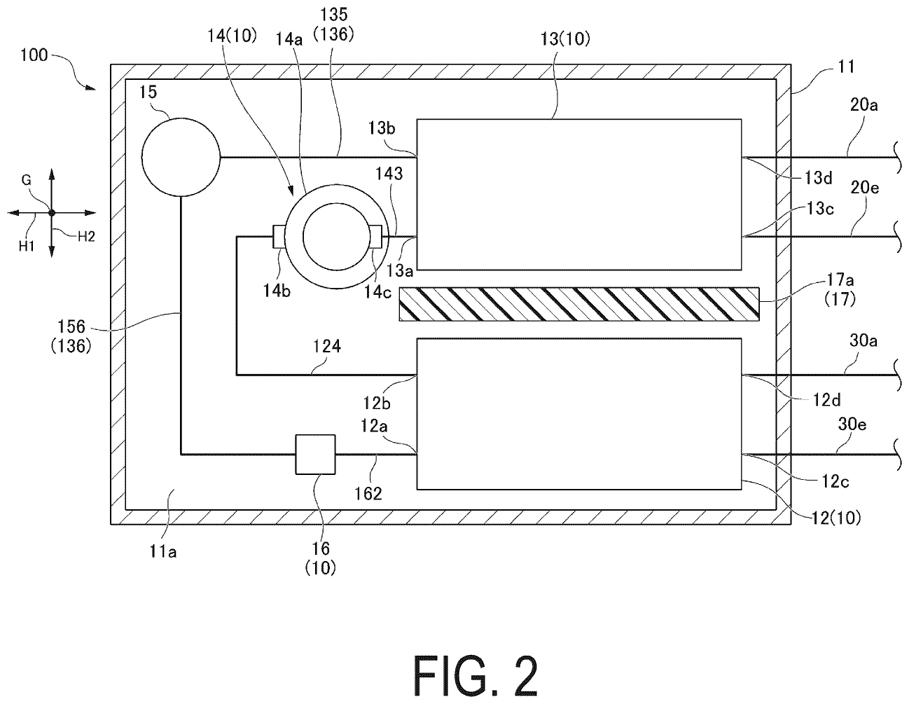

As illustrated in FIG. 2, the vehicular refrigeration cycle unit 100 includes a casing 11, a refrigeration cycle 10, various lines (a suction line 124, a discharge line 143, a pre-expansion line 136, and a post-expansion line 162), and a partition wall portion 17.

### Casing

The casing 11 has a box shape, and accommodates the refrigeration cycle 10, the partition wall portion 17, the suction line 124, the discharge line 143, the pre-expansion line 136, and the post-expansion line 162.

### Refrigeration Cycle

The refrigeration cycle 10 includes a plurality of devices that configure a thermodynamic cycle. The refrigeration cycle 10 is a refrigerant circuit in which the primary refrigerant serving as a heat medium is made to sequentially flow and circulate through the plurality of devices while being repeatedly compressed and expanded, and evaporated and condensed, so as to exchange heat with the secondary refrigerant.

The refrigeration cycle 10 includes an evaporator 12, a compressor 14, a condenser 13, a receiver 15, and an expansion valve 16.

### Evaporator

The evaporator 12 is a plate-type heat exchanger that evaporates (gasifies) the primary refrigerant by heat exchange between the primary refrigerant sequentially flowing through the refrigeration cycle 10 and the secondary refrigerant introduced from the outside of the vehicular refrigeration cycle unit 100. The primary refrigerant in the evaporator 12 absorbs heat from the secondary refrigerant while simultaneously cooling the secondary refrigerant. The evaporator 12 is provided at a bottom surface 11a of the casing 11 inside the casing 11.

### Compressor

The compressor 14 is a device for compressing the primary refrigerant that has absorbed heat to be gasified by passing through the evaporator 12. The compressor 14 and the evaporator 12 are connected to each other by the suction line 124. That is, one end of the suction line 124 is connected to a primary refrigerant outlet section 12b of the evaporator 12, and the other end of the suction line 124 is connected to a suction port 14b of the compressor 14.

The pressure of the primary refrigerant introduced into the compressor 14 is increased through compression by the compressor 14 to a predetermined pressure higher than the pressure before the compression. As a result, the temperature of the primary refrigerant becomes higher than before the compression.

The compressor 14 includes a compressor casing 14a, a suction port 14b, and a discharge port 14c.

The compressor casing 14a has a tube shape and is disposed so as to extend in a gravitational direction G from the bottom surface 11a of the casing 11 inside the casing 11. The compressor 14 in the present embodiment is a so-called vertical compressor. A refrigerant compression mechanism is formed inside the compressor casing 14a.

The suction port 14b is a refrigerant inlet section for introducing a refrigerant into the compressor casing 14a. The suction port 14b is provided at an end portion of the compressor casing 14a on a lower side in the gravitational direction G. The primary refrigerant is introduced into the compressor casing 14a through the suction port 14b.

The discharge port 14c is a refrigerant outlet section for discharging a refrigerant from the compressor casing 14a. The discharge port 14c is provided at an end portion of the compressor casing 14a on an upper side in the gravitational direction G. The primary refrigerant is discharged to the outside of the compressor casing 14a through the discharge port 14c. The discharge port 14c is a portion of the compressor 14 at which the temperature becomes the highest.

### Condenser

The condenser 13 is a plate-type heat exchanger that condenses (liquefies) the primary refrigerant by heat exchange between the primary refrigerant, which has a higher temperature and a higher pressure than before being compressed by passing through the compressor 14, and the secondary refrigerant introduced from the outside of the vehicular refrigeration cycle unit 100. The condenser 13 is provided at the bottom surface 11a of the casing 11 inside the casing 11.

The condenser 13 and the compressor 14 are connected to each other by the discharge line 143. That is, one end of the discharge line 143 is connected to the discharge port 14c of the compressor 14, and the other end of the discharge line 143 is connected to a primary refrigerant inlet section 13a of the condenser 13. The primary refrigerant in the condenser 13 is cooled by the secondary refrigerant while increasing the temperature of the secondary refrigerant.

The primary refrigerant in a gas state introduced into the condenser 13 is cooled by the secondary refrigerant to enter a gas-liquid two-phase state, and then to transition into a liquid state. Accordingly, the primary refrigerant having passed through the condenser 13 becomes a fluid in a liquid mixed state.

The condenser 13 is disposed adjacent to the compressor 14 inside the casing 11. In the present embodiment, a direction in which the condenser 13 is adjacent to the compressor 14 (the left-right direction in FIG. 2) is referred to as a first adjacent direction H1, and a direction orthogonal to the first adjacent direction H1 (the up-down direction in FIG. 2) is referred to as a second adjacent direction H2. The first adjacent direction H1 and the second adjacent direction H2 are orthogonal to the gravitational direction G. Thus, a horizontal direction is defined by the first adjacent direction H1 and the second adjacent direction H2.

Here, the evaporator 12 is adjacent to the condenser 13 from one side in the second adjacent direction H2. While the condenser 13 is adjacent to the compressor 14 in the first adjacent direction H1, the evaporator 12 is only separated from the compressor 14 in the horizontal direction and is not adjacent to the compressor 14 in both the first adjacent direction H1 and the second adjacent direction H2. Thus, the distance between the compressor 14 and the evaporator 12 is longer than the distance between the compressor 14 and the condenser 13.

Further, the discharge port 14c of the compressor 14 in the present embodiment faces the condenser 13 in the first adjacent direction H1. Thus, a distance between the discharge port 14c for the primary refrigerant at the compressor 14 and the evaporator 12 is longer than a distance between the discharge port 14c and the condenser 13. More specifically, a length of a pipe connecting the compressor 14 and the evaporator 12, that is, a length of the suction line 124 is longer than a length of a pipe connecting the compressor 14 and the condenser 13, that is, the length of the discharge line 143.

Note that “adjacent in the first adjacent direction H1” means that more than half of the size in the second adjacent direction H2 of one of two objects arranged side by side inside the casing 11 overlaps the size in the second adjacent direction H2 of the other object when viewed from the first adjacent direction H1. Further, “adjacent in the second adjacent direction H2” means that more than half of the size in the first adjacent direction H1 of one of two objects arranged side by side inside the casing 11 overlaps the size in the first adjacent direction H1 of the other object when viewed from the second adjacent direction H2.

### Receiver

The receiver 15 is a gas-liquid separator that receives the primary refrigerant having become a fluid in a gas-liquid mixed state by passing through the condenser 13, separates the primary refrigerant into a gas phase and a liquid phase, and temporarily retains the gas phase and the liquid phase. The receiver 15 is provided at the bottom surface 11a of the casing 11 inside the casing 11.

The receiver 15 and the condenser 13 are connected to each other by a first line 135 of the pre-expansion line 136. That is, one end of the first line 135 is connected to a primary refrigerant outlet section 13b of the condenser 13, and the other end of the first line 135 is connected to a refrigerant inlet section of the receiver 15.

The primary refrigerant in the gas-liquid mixed state introduced into the receiver 15 flows into a liquid phase portion retained inside the receiver 15. A liquid part of the primary refrigerant having flowed in is added to the liquid phase, and the remaining gas part becomes bubbles, moves upward inside the receiver 15, and is added to the gas phase. The primary refrigerant retained as the liquid phase inside the receiver 15 is discharged to the outside of the receiver 15. Thus, the primary refrigerant in a liquid state is constantly supplied from the receiver 15.

### Expansion Valve

The expansion valve 16 is a device that receives the primary refrigerant having entered a liquid state by passing through the receiver 15, and adiabatically expands the primary refrigerant. The expansion valve 16 is provided at the bottom surface 11a of the casing 11 inside the casing 11. The expansion valve 16 and the receiver 15 are connected to each other by a second line 156 of the pre-expansion line 136. That is, one end of the second line 156 is connected to a refrigerant outlet section of the receiver 15, and the other end of the second line 156 is connected to the expansion valve 16.

The pressure of the primary refrigerant introduced into the expansion valve 16 is decreased by an expansion effect of the expansion valve 16 to a predetermined pressure lower than before the expansion. As a result, the temperature of the primary refrigerant becomes lower than before the expansion. Specifically, the primary refrigerant having passed through the expansion valve 16 becomes a fluid in a liquid state and is decreased to a temperature lower than the temperature of the secondary refrigerant that is a heat-exchange destination.

The expansion valve 16 and the evaporator 12 are connected by the post-expansion line 162, and the primary refrigerant having passed through the expansion valve 16 is introduced into the evaporator 12 through the post-expansion line 162. That is, one end of the post-expansion line 162 is connected to the expansion valve 16, and the other end of the post-expansion line 162 is connected to a primary refrigerant inlet section 12a of the evaporator 12.

### Partition Wall Portion

The partition wall portion 17 is a heat insulating member provided between the evaporator 12 and the condenser 13 inside the casing 11. The thermal conductivity of the partition wall portion 17 is lower than the thermal conductivity of the casing 11. In the present embodiment, the partition wall portion 17 includes a partition wall plate 17a which is a plate member standing upward in the gravitational direction G from the bottom surface 11a of the casing 11 inside the casing 11 and separating the evaporator 12 and the condenser 13 from each other. That is, the longitudinal direction of the partition wall plate 17a coincides with the first adjacent direction H1. Thus, heat transfer via air between the evaporator 12 and the condenser 13 is suppressed. More specifically, since the partition wall plate 17a provided at the bottom surface 11a is interposed between the evaporator 12 and the condenser 13, thermal conduction through a bottom portion of the casing 11 constituting the bottom surface 11a, convective flow of air in the casing 11, and heat radiation from the condenser 13 to the evaporator 12 are suppressed. In the present embodiment, the thermal conduction, convective flow, and heat radiation are collectively referred to as “heat transfer”. As a material constituting the partition wall plate 17a, for example, rubber or resin is used. Note that the partition wall plate 17 may be formed of the same material as the casing 11.

### Vehicle-Interior Heat Medium Circuit

The vehicle-interior heat medium circuit 20 is a refrigerant circuit through which the secondary refrigerant having exchanged heat with the primary refrigerant in the refrigeration cycle 10 flows and which conditions air in the vehicle interior. For the secondary refrigerant in the present embodiment, an antifreezing liquid such as ethylene glycol is used as a liquid coolant (cooling water).

As illustrated in FIG. 1, the vehicle-interior heat medium circuit 20 includes a heater core 21a (vehicle-interior heat exchanger 21), a cooler core 21b (vehicle-interior heat exchanger 21), a first pump 22, a first valve 23, a second valve 24, and various lines (first heat medium line 20a to seventh heat medium line 20g).

The heater core 21a and the cooler core 21b are heat exchangers for causing indoor air inside the vehicle body C and outdoor air outside the vehicle body C to exchange heat with the secondary refrigerant. The secondary refrigerant having passed through the condenser 13 of the vehicular refrigeration cycle unit 100 is introduced into the heater core 21a. In the process of introducing the secondary refrigerant from the condenser 13 to the heater core 21a, the secondary refrigerant passes through the first pump 22 and the first valve 23.

The first pump 22 is a pump that pumps the secondary refrigerant having passed through the condenser 13 to the heater core 21a. The first heat medium line 20a serving as a flow path for suctioning the secondary refrigerant into the first pump 22 connects the condenser 13 and the first pump 22. That is, one end of the first heat medium line 20a is connected to a secondary refrigerant outlet section 13d of the condenser 13, and the other end of the first heat medium line 20a is connected to a refrigerant suction port of the first pump 22.

The second heat medium line 20b serving as a flow path for discharging the secondary refrigerant from the first pump 22 toward the heater core 21a connects the first pump 22 and the first valve 23. That is, one end of the second heat medium line 20b is connected to a refrigerant discharge port of the first pump 22, and the other end of the second heat medium line 20b is connected to the first valve 23. The first valve 23 is a three-way valve that can change the flow path (destination) of the secondary refrigerant.

The first valve 23 and the heater core 21a are connected by a third heat medium line 20c. That is, one end of the third heat medium line 20c is connected to the first valve 23, and the other end of the third heat medium line 20c is connected to the heater core 21a.

The secondary refrigerant introduced into the heater core 21a is cooled by heat exchange with the indoor air and the outdoor air introduced into the vehicle body C while increasing the temperatures of the indoor air and the outdoor air. Accordingly, the air in the vehicle body C can be heated. For example, outdoor air outside the vehicle body C introduced by a blower (not illustrated) disposed upstream of the heater core 21a and the cooler core 21b is used as the outdoor air.

The secondary refrigerant cooled in the heater core 21a is returned to the condenser 13 via the second valve 24. The second valve 24 is a three-way valve that can change the flow path (destination) of the secondary refrigerant. The first valve 23 and the heater core 21a are connected by the fourth heat medium line 20d. That is, one end of the fourth heat medium line 20d is connected to a refrigerant outlet section of the heater core 21a, and the other end of the fourth heat medium line 20d is connected to the second valve 24.

The second valve 24 and the condenser 13 are connected by a fifth heat medium line 20e. That is, one end of the fifth heat medium line 20e is connected to the second valve 24, and the other end of the fifth heat medium line 20e is connected to a secondary refrigerant inlet section 13c of the condenser 13.

With the configuration described above, the secondary refrigerant sequentially flows through the condenser 13, the first pump 22, and the heater core 21a, and returns to the condenser 13. By repeating this circulation, the heating operation is achieved, and an increase in temperature in the vehicle interior can be maintained.

Here, the cooler core 21b is provided in the vehicle body C independently of the heater core 21a. During the cooling operation, the secondary refrigerant having passed through the evaporator 12 is introduced into the cooler core 21b so as to exchange heat between the secondary refrigerant and outdoor air. The flow of the secondary refrigerant during the cooling operation will be described below.

### Vehicle-Exterior Heat Medium Circuit

The vehicle-exterior heat medium circuit 30 is a refrigerant circuit through which the secondary refrigerant having exchanged heat with the primary refrigerant in the refrigeration cycle 10 flows and which cools a battery for driving the vehicle body.

The vehicle-exterior heat medium circuit 30 includes a vehicle-exterior heat exchanger 31, a second pump 32, various valves (a third valve 33 and a fifth valve 35), a battery cooler 36, and various lines (an eighth heat medium line 30a to a twelfth heat medium line 30e, and a first connection line 30f to a fourth connection line 30i).

The vehicle-exterior heat exchanger 31 is a heat exchanger for exchanging heat between the outdoor air and the secondary refrigerant. A part of the secondary refrigerant having passed through the evaporator 12 of the vehicular refrigeration cycle unit 100 is introduced into the vehicle-exterior heat exchanger 31 via the third valve 33. The remaining part of the secondary refrigerant having passed through the evaporator 12 is introduced into the battery cooler 36 via the fourth valve 34.

The evaporator 12 is connected to the third valve 33 and the fourth valve 34 by the eighth heat medium line 30a. Specifically, one end of the eighth heat medium line 30a is connected to a secondary refrigerant outlet section 12d of the evaporator 12, and the other end of the eighth heat medium line 30a is branched in two directions partway along the eighth heat medium line 30a and connected to the third valve 33 and the fourth valve 34, respectively. The third valve 33 and the fourth valve 34 are three-way valves that can change the flow path (destination) of the secondary refrigerant.

The third valve 33 and the vehicle-exterior heat exchanger 31 are connected by the ninth heat medium line 30b. That is, one end of the ninth heat medium line 30b is connected to the third valve 33, and the other end of the ninth heat medium line 30b is connected to a refrigerant inlet section of the vehicle-exterior heat exchanger 31.

The secondary refrigerant introduced into the vehicle-exterior heat exchanger 31 through the eighth heat medium line 30a, the third valve 33, and the ninth heat medium line 30b absorbs heat by heat exchange with the outdoor air. Accordingly, the temperature of the secondary refrigerant becomes higher than the temperature of the primary refrigerant introduced into the evaporator 12, and thus the secondary refrigerant can increase the temperature of the primary refrigerant flowing through the refrigeration cycle 10 in the evaporator 12. Outdoor air, which is a heat exchange destination of the vehicle-exterior heat exchanger 31, is suctioned from the outside of the vehicle body C via a front grille F by a blower B provided on a front side inside the vehicle body C.

The second pump 32 is a pump that pumps the secondary refrigerant whose temperature has been increased by the vehicle-exterior heat exchanger 31 to the evaporator 12. The secondary refrigerant having passed through the vehicle-exterior heat exchanger 31 passes through the fifth valve 35 in the process of being suctioned into the second pump 32. The fifth valve 35 is a three-way valve that can change the flow path (destination) of the secondary refrigerant.

The fifth valve 35 and the vehicle-exterior heat exchanger 31 are connected by the tenth heat medium line 30c. That is, one end of the tenth heat medium line 30c is connected to the vehicle-exterior heat exchanger 31, and the other end of the tenth heat medium line 30c is connected to the fifth valve 35.

The eleventh heat medium line 30d serving as a flow path for suctioning the secondary refrigerant into the second pump 32 connects the fifth valve 35 and the second pump 32. That is, one end of the eleventh heat medium line 30d is connected to the fifth valve 35, and the other end of the eleventh heat medium line 30d is connected to the second pump 32.

The second pump 32 and the evaporator 12 are connected by the twelfth heat medium line 30e. That is, one end of the twelfth heat medium line 30e is connected to the second pump 32, and the other end of the twelfth heat medium line 30e is connected to a secondary refrigerant inlet section 12c of the evaporator 12. Accordingly, the secondary refrigerant pumped by the second pump is introduced into the evaporator 12.

With the configuration described above, the secondary refrigerant sequentially flows through the evaporator 12, the vehicle-exterior heat exchanger 31, and the second pump 32, and returns to the evaporator 12. By repeating this circulation, an increase in the temperature of the primary refrigerant circulating through the refrigeration cycle 10 can be maintained by heat exchange in the evaporator 12.

Accordingly, the vehicular refrigeration cycle unit 100 is interposed between the vehicle-exterior heat exchanger 31 and the heater core 21a (vehicle-interior heat exchanger 21), and performs heat exchange between the secondary refrigerant flowing through the vehicle-exterior heat exchanger 31 and the secondary refrigerant flowing through the vehicle-interior heat exchanger 21.

The battery cooler 36 is a heat exchanger for cooling a battery. The battery cooler 36 is provided inside the vehicle body C. The above-described remaining part of the secondary refrigerant cooled by the evaporator 12 and flowing through the eighth heat medium line 30a is introduced into the battery cooler 36 via the fourth valve 34. The fourth valve 34 and the battery cooler 36 are connected by a first connection line 30f. That is, one end of the first connection line 30f is connected to the fourth valve 34, and the other end of the first connection line 30f is connected to a refrigerant inlet section of the battery cooler 36.

The secondary refrigerant heated by heat exchange with a battery (not illustrated) in the battery cooler 36 is returned to the evaporator 12. The battery cooler 36 and the eleventh heat medium line 30d are connected by the second connection line 30g. Specifically, one end of the second connection line 30g is connected to a refrigerant outlet section of the battery cooler 36, and the other end of the second connection line 30g is connected to a portion of the eleventh heat medium line 30d on the fifth valve 35 side with respect to the second pump 32. Thus, the secondary refrigerant having passed through the battery cooler 36 joins the eleventh heat medium line 30d via the second connection line 30g, and is pumped to the evaporator 12 again by the second pump 32.

Here, the fourth valve 34 and the cooler core 21b are connected by a sixth heat medium line 20f. That is, one end of the sixth heat medium line 20f is connected to the fourth valve 34, and the other end of the sixth heat medium line 20f is connected to a refrigerant inlet section of the heater core 21a. In addition, the cooler core 21b and the second connection line 30g are connected by the seventh heat medium line 20g. That is, one end of the seventh heat medium line 20g is connected to the cooler core 21b, and the other end of the seventh heat medium line 20g is connected to the second connection line 30g. Thus, the secondary refrigerant having passed through the evaporator 12 during the cooling operation of the vehicular air conditioning device 1 can flow into the cooler core 21b via the fourth valve 34.

During the heating operation, the fourth valve 34 causes the secondary refrigerant having flowed in from the eighth heat medium line 30a to flow only to the first connection line 30f without flowing to the sixth heat medium line 20f. That is, the fourth valve 34 does not supply the secondary refrigerant to the cooler core 21b but supplies the secondary refrigerant only to the battery cooler 36.

Further, the first valve 23 and the fifth valve 35 are connected by the third connection line 30h. That is, one end of the third connection line 30h is connected to the first valve 23, and the other end of the third connection line 30h is connected to the fifth valve 35.

During the heating operation, the first valve 23 causes the secondary refrigerant having flowed in from the second heat medium line 20b to flow only to the third heat medium line 20c without flowing to the third connection line 30h. The fifth valve 35 causes the secondary refrigerant having flowed in from the tenth heat medium line 30c to flow only to the eleventh heat medium line 30d without flowing to the third connection line 30h.

In addition, the second valve 24 and the third valve 33 are connected by the fourth connection line 30i. That is, one end of the fourth connection line 30i is connected to the second valve 24, and the other end of the fourth connection line 30i is connected to the third valve 33.

During the heating operation, the second valve 24 causes the secondary refrigerant having flowed in from the fourth heat medium line 20d to flow only to the fifth heat medium line 20e without flowing to the fourth connection line 30i. The third valve 33 causes the secondary refrigerant having flowed in from the eighth heat medium line 30a to flow only to the ninth heat medium line 30b without flowing to the fourth connection line 30i.

### Operational Effects

In the vehicular refrigeration cycle unit 100 according to the above-described embodiment, for the compressor 14, the evaporator 12 and the condenser 13 constituting the refrigeration cycle 10, a distance between the compressor 14 and the evaporator 12 is longer than a distance between the compressor 14 and the condenser 13, and thus the amount of heat such as radiant heat transferred from the compressor 14 to the evaporator 12 is smaller than the amount of heat transferred to the condenser 13. Thus, an increase in the temperature of the evaporator 12 caused by the compressor 14 can be suppressed more than an increase in the temperature of the condenser 13 caused by the compressor 14. Accordingly, a decrease in the heat exchange efficiency between the primary refrigerant and the secondary refrigerant in the evaporator 12 can be suppressed.

In the vehicular refrigeration cycle unit 100 according to the above-described embodiment, since the distance between the discharge port 14c for the primary refrigerant at the compressor 14 and the evaporator 12 is longer than the distance between the discharge port 14c and the condenser 13, the amount of heat such as radiant heat transferred from discharge port 14c of the compressor 14 to the evaporator 12 is smaller than the amount of heat of radiant heat transferred to the condenser 13. As a result, the same operational effects as described above can be achieved.

In the vehicular refrigeration cycle unit 100 according to the above-described embodiment, since the length of the pipe connecting the compressor 14 and the evaporator 12 is longer than the length of the pipe connecting the compressor 14 and the condenser 13, heat is less likely to be transferred from the compressor 14 to the evaporator 12 through these pipes. As a result, the same operational effects as described above can be achieved.

The vehicular refrigeration cycle unit 100 according to the above-described embodiment includes the partition wall portion 17 separating the condenser 13 and the evaporator 12 from each other between the condenser 13 and the evaporator 12, heat transfer from the condenser 13 to the evaporator 12 can be suppressed by the partition wall portion 17. Thus, an increase in the temperature of the evaporator caused by the condenser can be suppressed.

In addition, since the partition wall portion 17 of the vehicular refrigeration cycle unit 100 according to the above-described embodiment is a plate member, heat transfer from the condenser 13 to the evaporator 12 can be suppressed with a simple configuration of the plate member.

### Second Embodiment

A vehicular air conditioning device 1 according to a second embodiment of the present disclosure will be described below. The vehicular refrigeration cycle unit 100 described in the second embodiment is different from the vehicular refrigeration cycle unit 100 of the first embodiment in the configuration of the partition wall portion 17. The same components as those in the first embodiment are denoted by the same reference signs, and detailed descriptions thereof are omitted.

### Partition Wall Portion

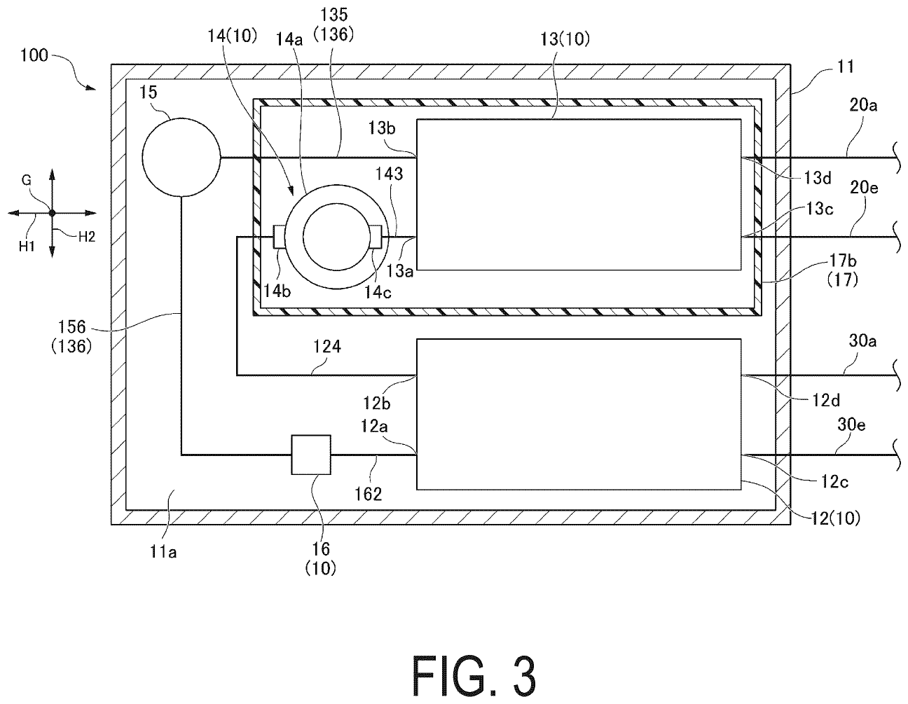

As illustrated in FIG. 3, the partition wall portion 17 is a heat insulating member provided between the evaporator 12 and the condenser 13 inside the casing 11. The partition wall portion 17 in the present embodiment includes an accommodation body 17b that accommodates only the compressor 14 and the condenser 13 out of the compressor 14, the condenser 13, and the evaporator 12 constituting the refrigeration cycle 10. That is, the casing 11 and the accommodation body 17b are in a nested relationship. Heat transfer between the evaporator 12 and the condenser 13 is suppressed by a partition wall of the accommodation body 17b. As a material constituting the accommodation body 17b, for example, rubber or resin is used.

### Operational Effects

In the vehicular refrigeration cycle unit 100 according to the above-described embodiment, heat such as radiant heat generated from the compressor 14 and the condenser 13 can be retained in the accommodation body 17b. Thus, the amount of heat transferred from the compressor 14 to the evaporator 12 is smaller than the amount of heat transferred to the condenser 13. Therefore, the same operational effects as in the first embodiment can be achieved.

### Third Embodiment

A vehicular air conditioning device 1 according to a third embodiment of the present disclosure will be described below. The vehicular refrigeration cycle unit 100 described in the second embodiment is different from the vehicular refrigeration cycle unit 100 of the first embodiment in the positional relationship between (arrangement of) the evaporator 12, the compressor 14, and the condenser 13 in the casing 11. The same components as those in the first embodiment are denoted by the same reference signs, and detailed descriptions thereof are omitted.

### Condenser

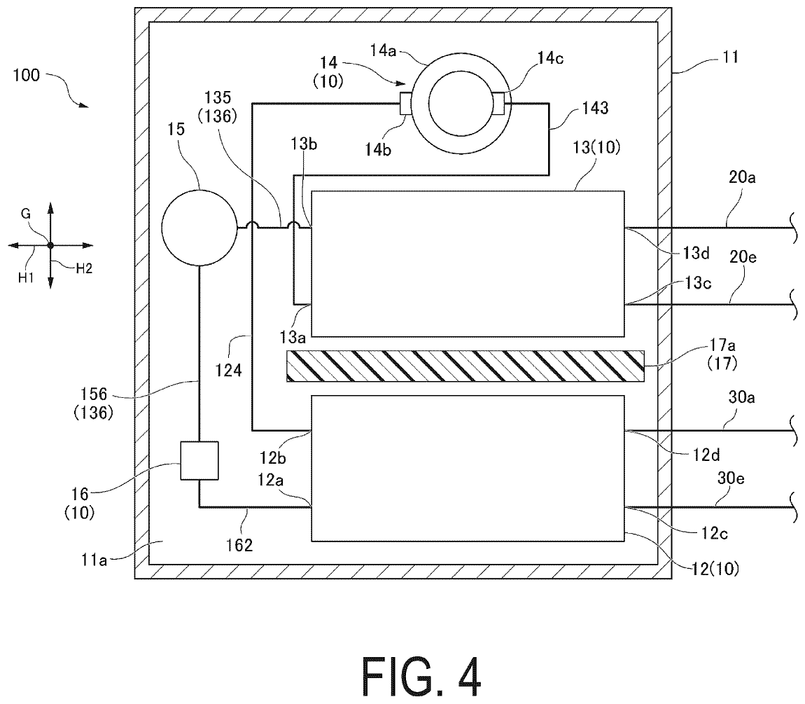

As illustrated in FIG. 4, the condenser 13 is disposed adjacent to the compressor 14 inside the casing 11. In the present embodiment, a direction in which the condenser 13 is adjacent to the compressor 14 (the up-down direction in FIG. 4) is referred to as a second adjacent direction H2, and a direction orthogonal to the second adjacent direction H2 (the left-right direction in FIG. 4) is referred to as a first adjacent direction H1. The first adjacent direction H1 and the second adjacent direction H2 are orthogonal to a weight direction. That is, a horizontal direction is defined by the first adjacent direction H1 and the second adjacent direction H2.

Here, the evaporator 12 is adjacent to the condenser 13 from one side in the second adjacent direction H2, and the compressor 14 is adjacent to the condenser 13 from the other side in the second adjacent direction H2. That is, the condenser 13 is disposed between the compressor 14 and the evaporator 12. Thus, the distance between the compressor 14 and the evaporator 12 is longer than the distance between the compressor 14 and the condenser 13.

Further, the discharge port 14c of the compressor 14 in the present embodiment faces one side in the first adjacent direction H1, and the distance between the discharge port 14c and the evaporator 12 is longer than the distance between the discharge port 14c and the condenser 13. More specifically, the length of the pipe connecting the compressor 14 and the evaporator 12, that is, the length of the suction line 124 is longer than the length of the pipe connecting the compressor 14 and the condenser 13, that is, the length of the discharge line 143.

### Operational Effects

In the vehicular refrigeration cycle unit 100 according to the above-described embodiment, since the condenser 13 is disposed between the compressor 14 and the evaporator 12, the amount of heat such as radiant heat transferred from the compressor 14 to the evaporator 12 is smaller than the amount of heat transferred to the condenser 13. Therefore, the same operational effects as in the first embodiment can be achieved.

### Fourth Embodiment

A vehicular air conditioning device 1 according to a fourth embodiment of the present disclosure will be described below. The vehicular refrigeration cycle unit 100 described in the fourth embodiment is different from the vehicular refrigeration cycle unit 100 of the third embodiment in the configuration of the partition wall portion 17. The same components as those in the third embodiment are denoted by the same reference signs, and detailed descriptions thereof are omitted.

### Partition Wall Portion

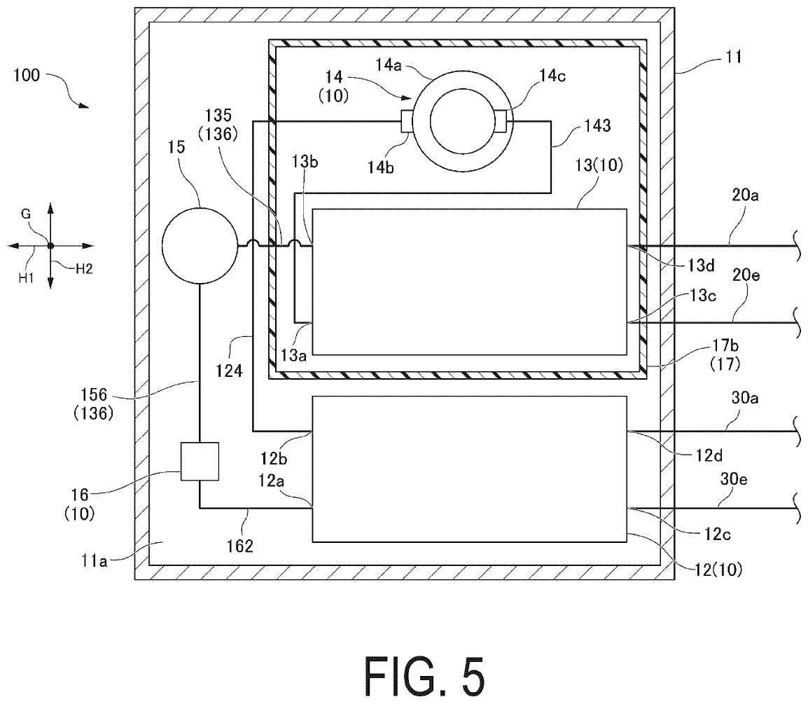

As illustrated in FIG. 5, the partition wall portion 17 is a heat insulating member provided between the evaporator 12 and the condenser 13 inside the casing 11. The partition wall portion 17 in the present embodiment includes the accommodation body 17b that accommodates only the compressor 14 and the condenser 13 out of the compressor 14, the condenser 13, and the evaporator 12 constituting the refrigeration cycle 10. That is, the casing 11 and the accommodation body 17b are in a nested relationship. Direct heat transfer via air between the evaporator 12 and the condenser 13 is suppressed by a partition wall of the accommodation body 17b.

### Operational Effects

In the vehicular refrigeration cycle unit 100 according to the above-described embodiment, heat such as radiant heat generated from the compressor 14 and the condenser 13 can be retained in the accommodation body 17b. Thus, the amount of heat transferred from the compressor 14 to the evaporator 12 is smaller than the amount of heat transferred to the condenser 13. Therefore, the same operational effects as in the first embodiment can be achieved.

### Fifth Embodiment

A vehicular air conditioning device 1 according to a fifth embodiment of the present disclosure will be described below. The vehicular refrigeration cycle unit 100 described in the fifth embodiment is different from the vehicular refrigeration cycle unit 100 of the first embodiment in the arrangement of the compressor 14. The same components as those in the first embodiment are denoted by the same reference signs, and detailed descriptions thereof are omitted.

### Compressor

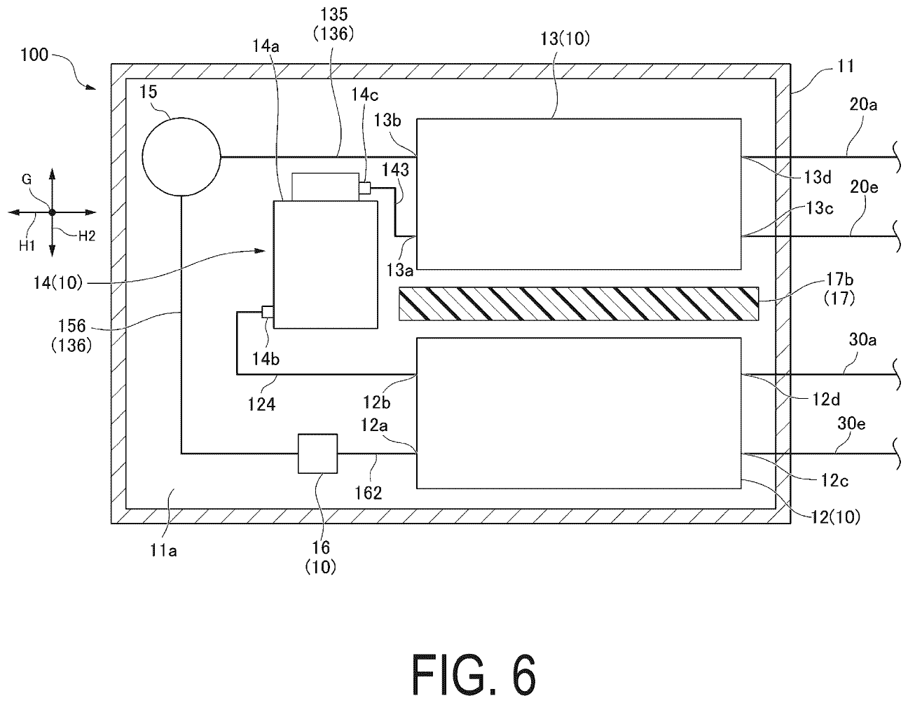

As illustrated in FIG. 6, the compressor 14 includes the compressor casing 14a, the suction port 14b, and the discharge port 14c.

The compressor casing 14a has a tube shape and is disposed so as to extend in the second adjacent direction H2 at the bottom surface 11a of the casing 11 inside the casing 11. The compressor 14 in the present embodiment is a so-called vertical compressor. A refrigerant compression mechanism is formed inside the compressor casing 14a.

The suction port 14b is a refrigerant inlet section for introducing a refrigerant into the compressor casing 14a. The suction port 14b is provided at an end portion of the compressor casing 14a on one side in the second adjacent direction H2. That is, the suction port 14b is provided at the compressor casing 14a on a side of the condenser 13 out of the evaporator 12 and the condenser 13. The primary refrigerant is introduced into the compressor casing 14a through the suction port 14b. The suction port 14b is a portion of the compressor 14 at which the temperature becomes the lowest.

The discharge port 14c is a refrigerant outlet section for discharging a refrigerant from the compressor casing 14a. The discharge port 14c is provided at an end portion of the compressor casing 14a on the other side in the second adjacent direction H2. That is, the discharge port 14c is provided at the compressor casing 14a on a side of the evaporator 12 out of the evaporator 12 and the condenser 13. The primary refrigerant is discharged to the outside of the compressor casing 14a through the discharge port 14c. The discharge port 14c is a portion of the compressor 14 at which temperature becomes the highest. Thus, the compressor casing 14a has a temperature distribution in which temperature gradually increases from a side of the suction port 14b to a side of the discharge port 14c.

### Operational Effects

In the vehicular refrigeration cycle unit 100 according to the above-described embodiment, the suction port 14b is disposed at the compressor casing 14a on a side of the condenser 13 out of the evaporator 12 and the condenser 13 and the discharge port 14c is provided at the compressor casing 14a on a side of the evaporator 12, and thus the amount of heat such as radiant heat transferred from the compressor 14 to the evaporator 12 is smaller than the amount of heat transferred to the condenser 13. Therefore, the same operational effects as in the first embodiment can be achieved.

### OTHER EMBODIMENTS

The embodiments of the present disclosure have been described above in detail with reference to the drawings. However, specific configurations are not limited to the configurations of each of the embodiments. Any configuration can be added, omitted, substituted, or otherwise modified, as long as such addition, omission, substitution, or modification does not depart from the scope of the present disclosure. Furthermore, the present disclosure is not to be considered as being limited by the embodiments and is only limited by the scope of the appended claims.

In the above-described embodiments, the configuration in which the vehicular air conditioning device 1 performs the heating operation has been described as an example. However, the configuration is not limited to the heating operation, and the vehicular refrigeration cycle unit 100 may employ a configuration similar to the configuration of the above-described embodiments even in the case where cooling operation is performed.

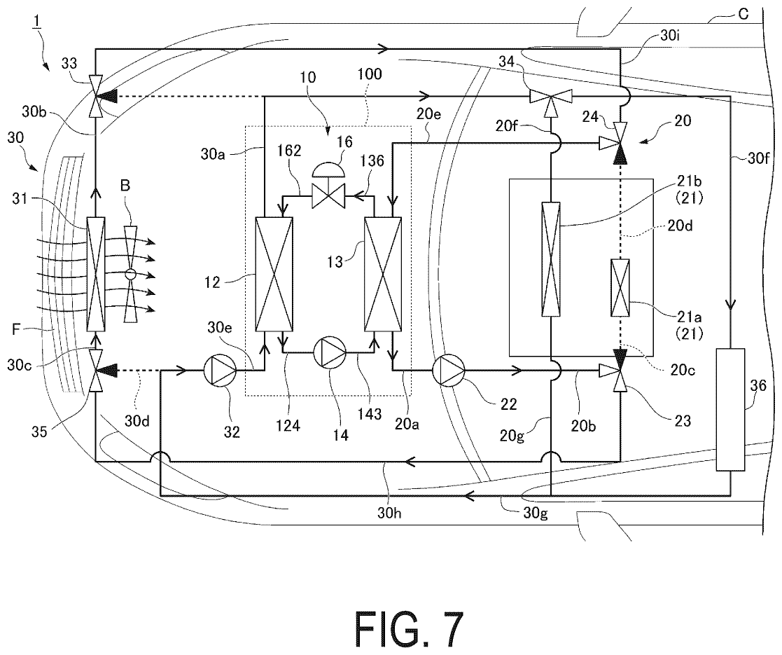

Hereinafter, configurations of the vehicle-interior heat medium circuit 20 and the vehicle-exterior heat medium circuit 30 during the cooling operation will be described with reference to FIG. 7.

The first pump 22 pumps the secondary refrigerant condensed by the condenser 13 to the vehicle-exterior heat exchanger 31. The first heat medium line 20a serving as a flow path for suctioning the secondary refrigerant into the first pump 22 connects the condenser 13 and the first pump 22.

The second heat medium line 20b serving as a flow path for discharging the secondary refrigerant from the first pump 22 toward the vehicle-exterior heat exchanger 31 connects the first pump 22 and the first valve 23. Here, the first valve 23 causes the secondary refrigerant discharged from the first pump 22 to flow to the fourth connection line 30i without flowing to the third heat medium line 20c. The secondary refrigerant having flowed into the fourth connection line 30i flows into the third valve 33.

Here, the third valve 33 causes the secondary refrigerant having flowed in from the fourth connection line 30i to flow to the tenth heat medium line 30c without flowing to the eleventh heat medium line 30d. The secondary refrigerant having flowed into the tenth heat medium line 30c flows into the vehicle-exterior heat exchanger 31.

The secondary refrigerant having passed through the vehicle-exterior heat exchanger 31 flows into the fourth valve 34 via the ninth heat medium line 30b. Thus, a flow direction of the secondary refrigerant flowing through the tenth heat medium line 30c, the vehicle-exterior heat exchanger 31, and the ninth heat medium line 30b during the cooling operation of the vehicular air conditioning device 1 is opposite to a flow direction of the secondary refrigerant during the heating operation.

Here, the fourth valve 34 causes the secondary refrigerant having flowed in from the ninth heat medium line 30b to flow to the third connection line 30h without flowing to the eighth heat medium line 30a. The secondary refrigerant having flowed into the third connection line 30h flows into the second valve 24.

Here, the second valve 24 causes the secondary refrigerant having flowed in from the third connection line 30h to flow to the fifth heat medium line 20e without flowing to the fourth heat medium line 20d. The secondary refrigerant having flowed into the fifth heat medium line 20e flows into the condenser 13.

With the configuration described above, the secondary refrigerant sequentially flows through the condenser 13, the first pump 22, and the vehicle-exterior heat exchanger 31, and returns to the condenser 13. By repeating this circulation, the primary refrigerant circulating through the refrigeration cycle 10 can be continuously cooled by heat exchange in the condenser 13.

The second pump 32 pumps the secondary refrigerant cooled by the evaporator 12 to the cooler core 21b. The secondary refrigerant having passed through the evaporator 12 is introduced into the eighth heat medium line 30a and then into the fifth valve 35 by the suction force of the pump. Here, the fifth valve 35 causes the secondary refrigerant having flowed in from the eighth heat medium line 30a to flow to both the sixth heat medium line 20f and the first connection line 30f.

The secondary refrigerant having flowed into the sixth heat medium line 20f flows into the cooler core 21b. The secondary refrigerant having completed heat exchange in the cooler core 21b flows into the seventh heat medium line 20g, and then flows into the second connection line 30g. The secondary refrigerant having flowed into the second connection line 30g flows into the eleventh heat medium line 30d, and returns to the evaporator 12 via the second pump 32 and the twelfth heat medium line 30e.

The secondary refrigerant having flowed into the first connection line 30f flows into the battery cooler 36. Thus, the battery cooler 36 exchanges heat with (is cooled by) the secondary refrigerant during both the heating operation and the cooling operation of the vehicular air conditioning device 1. The secondary refrigerant having completed heat exchange in the battery cooler 36 flows into the second connection line 30g. The secondary refrigerant having flowed into the second connection line 30g flows into the eleventh heat medium line 30d, and returns to the evaporator 12 via the second pump 32 and the twelfth heat medium line 30e.

With the configuration described above, the secondary refrigerant sequentially flows through the evaporator 12, the cooler core 21b, and the second pump 32, and returns to the evaporator 12. By repeating this circulation, the cooling operation is achieved, and the vehicle interior can be continuously cooled.

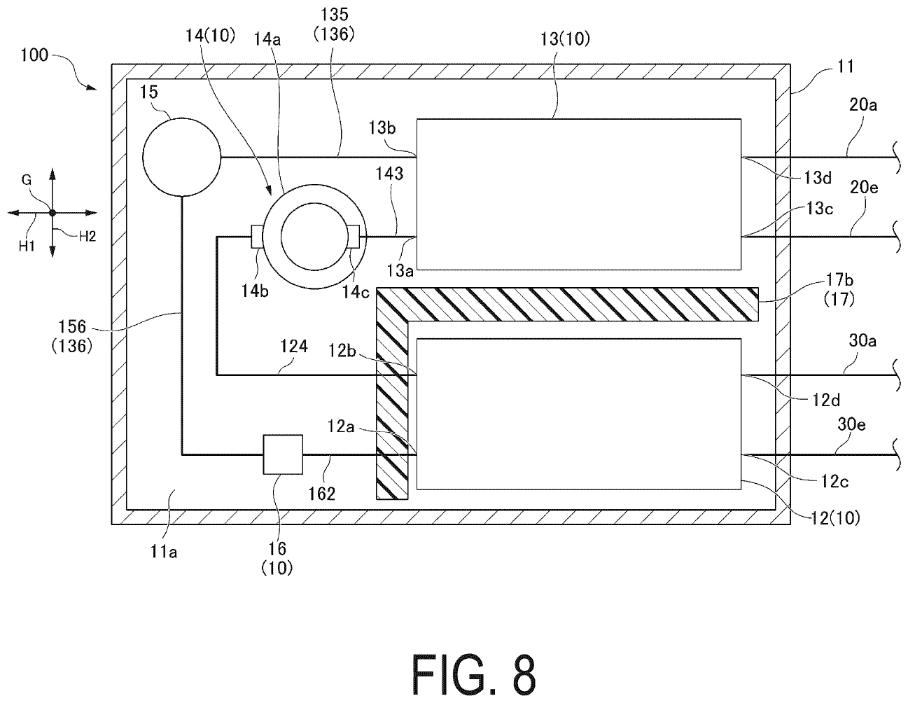

The partition wall plate 17a included in the partition wall portion 17 in the above-described embodiments is not limited to the configurations of the first embodiment and the third embodiment. For example, as illustrated in FIG. 8, the partition wall plate 17a may be disposed so as to separate the condenser 13 and the evaporator 12 from each other and to separate the expansion valve 16 and the evaporator 12 from each other in the casing 11. Accordingly, heat transfer to the evaporator 12 can be further suppressed.

In the above-described embodiments, an example in which an R290 refrigerant is used as the primary refrigerant and ethylene glycol is used as the secondary refrigerant has been described, but other refrigerants may be used as the primary refrigerant and the secondary refrigerant.

The vehicle-exterior heat medium circuit 30 in the above-described embodiments may further include a traction motor cooler (not illustrated) that is a heat exchanger for cooling a traction motor, and an inverter cooler (not illustrated) that is a heat exchanger for cooling an inverter (power converter). In that case, the secondary refrigerant having passed through the vehicle-exterior heat exchanger 31 is introduced into each of the traction motor cooler and the inverter cooler as cooling water for cooling the traction motor and the inverter through pipes (not illustrated) that connect the vehicle-exterior heat exchanger 31 to the traction motor cooler and the inverter cooler. Furthermore, the secondary refrigerant heated by heat exchange in the traction motor cooler and the inverter cooler may flow into the eleventh heat medium line 30d through a pipe, similarly to the secondary refrigerant flowing through the second connection line 30g from the battery cooler 36 toward the eleventh heat medium line 30d.

In addition, the vehicular refrigeration cycle unit 100 according to the above-described embodiments may further include a bracket that includes an upper surface facing upward in the gravitational direction G. The bracket fixes the evaporator 12, the compressor 14, and the condenser 13 to the upper surface in a state of being interposed between the refrigeration cycle 10 and the bottom surface 11a of the casing 11. In that case, for example, the bracket fixes the refrigeration cycle 10 to the upper surface in a state of being fixed to an inner wall surface of a front compartment or the like outside the vehicle interior. Thus, the refrigeration cycle 10 may be provided at the bottom surface 11a of the casing 11 via the bracket. In that case, the thermal conductivity of the partition wall portion 17 is lower than the thermal conductivity of the bracket.

### Supplementary Notes

The vehicular refrigeration cycle unit and the vehicular air conditioning device according to the above-described embodiments are understood as follows, for example.

(1) A vehicular refrigeration cycle unit 100 according to a first aspect is a vehicular refrigeration cycle unit 100 which is interposed between a vehicle-exterior heat exchanger 31 and a vehicle-interior heat exchanger 21 and exchanges heat between respective secondary refrigerants flowing through the vehicle-exterior heat exchanger 31 and the vehicle-interior heat exchanger 21. The vehicular refrigeration cycle unit 100 is provided with a refrigeration cycle 10 including a compressor 14, a condenser 13, an expansion valve 16, and an evaporator 12 through which a primary refrigerant sequentially flows. A distance between the compressor 14 and the evaporator 12 is longer than a distance between the compressor 14 and the condenser 13.

Accordingly, the amount of heat such as radiant heat transferred from the compressor 14 to the evaporator 12 becomes smaller than the amount of heat transferred to the condenser 13.

(2) A vehicular refrigeration cycle unit 100 according to a second aspect is a vehicular refrigeration cycle unit 100 which is interposed between a vehicle-exterior heat exchanger 31 and a vehicle-interior heat exchanger 21 and exchanges heat between respective secondary refrigerants flowing through the vehicle-exterior heat exchanger 31 and the vehicle-interior heat exchanger 21. The vehicular refrigeration cycle unit 100 is provided with a refrigeration cycle 10 including a compressor 14, a condenser 13, an expansion valve 16, and an evaporator 12 through which a primary refrigerant sequentially flows. A distance between a discharge port 14c for the primary refrigerant at the compressor 14 and the evaporator 12 is longer than a distance between the discharge port 14c and the condenser 13.

Thus, the amount of heat such as radiant heat transferred from the discharge port 14c of the compressor 14 to the evaporator 12 becomes smaller than the amount of radiant heat transferred to the condenser 13.

(3) A vehicular refrigeration cycle unit 100 according to a third aspect is a vehicular refrigeration cycle unit 100 which is interposed between a vehicle-exterior heat exchanger 31 and a vehicle-interior heat exchanger 21 and exchanges heat between respective secondary refrigerants flowing through the vehicle-exterior heat exchanger 31 and the vehicle-interior heat exchanger 21. The vehicular refrigeration cycle unit 100 is provided with a refrigeration cycle 10 including a compressor 14, a condenser 13, an expansion valve 16, and an evaporator 12 through which a primary refrigerant sequentially flows. A length of a pipe connecting the compressor 14 and the evaporator 12 is longer than a length of a pipe connecting the compressor 14 and the condenser 13.

Thus, heat is less likely to be transferred from the compressor 14 to the evaporator 12 through these pipes.

(4) A vehicular refrigeration cycle unit 100 according to a fourth aspect is the vehicular refrigeration cycle unit 100 according to any one of (1) to (3), wherein the condenser 13 may be disposed between the compressor 14 and the evaporator 12.

Accordingly, the amount of heat such as radiant heat transferred from the compressor 14 to the evaporator 12 becomes smaller than the amount of heat transferred to the condenser 13.

(5) A vehicular refrigeration cycle unit 100 according to a fifth aspect is the vehicular refrigeration cycle unit 100 according to any one of (1) to (3), wherein a partition wall portion 17 separating the condenser 13 and the evaporator 12 may be further provided between the condenser 13 and the evaporator 12.

Accordingly, heat transfer from the condenser 13 to the evaporator 12 can be suppressed by the partition wall portion 17.

(6) A vehicular refrigeration cycle unit 100 according to a sixth aspect is the vehicular refrigeration cycle unit 100 according to (5), wherein the partition wall portion 17 may include a partition wall plate 17a which is a plate member.

Accordingly, heat transfer from the condenser 13 to the evaporator 12 can be suppressed with a simple configuration of the plate member.

(7) A vehicular refrigeration cycle unit 100 according to a seventh aspect is the vehicular refrigeration cycle unit 100 according to (5), wherein the partition wall portion 17 may include an accommodation body 17b that accommodates only the compressor 14 and the condenser 13 out of the compressor 14, the condenser 13, and the evaporator 12.

Accordingly, heat such as radiant heat generated from the compressor 14 and the condenser 13 can be retained in the accommodation body 17b.

(8) A vehicular air conditioning device 1 according to an eighth aspect includes the vehicular refrigeration cycle unit 100 according to any one of (1) to (7), the vehicle-exterior heat exchanger 31, and the vehicle-interior heat exchanger 21.

### INDUSTRIAL APPLICABILITY

According to the present disclosure, it is possible to provide a vehicular refrigeration cycle unit and a vehicular air conditioning device that can suppress a decrease in a heat exchange efficiency of an evaporator.

### REFERENCE SIGNS LIST

1 Vehicular air conditioning device, 10 Refrigeration cycle, 11 Casing, 11a Bottom surface, 12 Evaporator, 12a, 13a Primary refrigerant inlet section, 12b, 13b Primary refrigerant outlet section, 12c, 13c Secondary refrigerant inlet section, 12d, 13d Secondary refrigerant outlet section, 13 Condenser, 14 Compressor, 14a Compressor casing, 14b Suction port, 14c Discharge port, 15 Receiver, 16 Expansion valve, 17 Partition wall portion, 17a Partition wall plate, 17b Accommodation body, 20 Vehicle-interior heat medium circuit, 20a First heat medium line. 20b Second heat medium line, 20c Third heat medium line, 20d Fourth heat medium line, 20e Fifth heat medium line, 20f Sixth heat medium line, 20g Seventh heat medium line, 21 Vehicle-interior heat exchanger, 21a Heater core, 21b Cooler core, 22 First pump, 23 First valve, 24 Second valve, 30 Vehicle-exterior heat medium circuit, 30a Eighth heat medium line, 30b Ninth heat medium line, 30c Tenth heat medium line, 30d Eleventh heat medium line, 30e Twelfth heat medium line, 30f First connection line, 30g Second connection line, 30h Third connection line, 30i Fourth connection line, 31 Vehicle-exterior heat exchanger, 32 Second pump, 33 Third valve, 34 Fourth valve, 35 Fifth valve, 36 Battery cooler, 100 Vehicular refrigeration cycle unit, 124 Suction line, 135 First line, 136 Pre-expansion line, 143 Discharge line, 156 Second line, 162 Post-expansion line, B Blower, C Vehicle body. F Front grille, G Gravitational direction, H1 First adjacent direction, H2 Second adjacent direction

1. A vehicular refrigeration cycle unit interposed between a vehicle-exterior heat exchanger and a vehicle-interior heat exchanger and being configured to exchange heat between respective secondary refrigerants flowing through the vehicle-exterior heat exchanger and the vehicle-interior heat exchanger, the vehicular refrigeration cycle unit comprising:
a refrigeration cycle including a compressor, a condenser, an expansion valve, and an evaporator through which a primary refrigerant sequentially flows;
a distance between the compressor and the evaporator being longer than a distance between the compressor and the condenser.

2. A vehicular refrigeration cycle unit interposed between a vehicle-exterior heat exchanger and a vehicle-interior heat exchanger and configured to exchange heat between respective secondary refrigerants flowing through the vehicle-exterior heat exchanger and the vehicle-interior heat exchanger, the vehicular refrigeration cycle unit comprising:
a refrigeration cycle including a compressor, a condenser, an expansion valve, and an evaporator through which a primary refrigerant sequentially flows;
a distance between a discharge port for the primary refrigerant at the compressor and the evaporator being longer than a distance between the discharge port and the condenser.

3. A vehicular refrigeration cycle unit interposed between a vehicle-exterior heat exchanger and a vehicle-interior heat exchanger and configured to exchange heat between respective secondary refrigerants flowing through the vehicle-exterior heat exchanger and the vehicle-interior heat exchanger, the vehicular refrigeration cycle unit comprising:
a refrigeration cycle including a compressor, a condenser, an expansion valve, and an evaporator through which a primary refrigerant sequentially flows;
a length of a pipe connecting the compressor and the evaporator being longer than a length of a pipe connecting the compressor and the condenser.

4. The vehicular refrigeration cycle unit according to claim 1, wherein the condenser is disposed between the compressor and the evaporator.

5. The vehicular refrigeration cycle unit according to claim 1, further comprising a partition wall portion separating the condenser and the evaporator from each other between the condenser and the evaporator.

6. The vehicular refrigeration cycle unit according to claim 5, wherein the partition wall portion includes a partition wall plate being a plate member.

7. The vehicular refrigeration cycle unit according to claim 5, wherein the partition wall portion includes an accommodation body configured to accommodate only the compressor and the condenser out of the compressor, the condenser, and the evaporator.

8. A vehicular air conditioning device comprising:
the vehicular refrigeration cycle unit according to claim 1;
the vehicle-exterior heat exchanger; and
the vehicle-interior heat exchanger.

9. The vehicular refrigeration cycle unit according to claim 2, wherein the condenser is disposed between the compressor and the evaporator.

10. The vehicular refrigeration cycle unit according to claim 2, further comprising a partition wall portion separating the condenser and the evaporator from each other between the condenser and the evaporator.

11. The vehicular refrigeration cycle unit according to claim 10, wherein the partition wall portion includes a partition wall plate being a plate member.

12. The vehicular refrigeration cycle unit according to claim 10, wherein the partition wall portion includes an accommodation body configured to accommodate only the compressor and the condenser out of the compressor, the condenser, and the evaporator.

13. A vehicular air conditioning device comprising:
the vehicular refrigeration cycle unit according to claim 2;
the vehicle-exterior heat exchanger; and
the vehicle-interior heat exchanger.

14. The vehicular refrigeration cycle unit according to claim 3, wherein the condenser is disposed between the compressor and the evaporator.

15. The vehicular refrigeration cycle unit according to claim 3, further comprising a partition wall portion separating the condenser and the evaporator from each other between the condenser and the evaporator.

16. The vehicular refrigeration cycle unit according to claim 15, wherein the partition wall portion includes a partition wall plate being a plate member.

17. The vehicular refrigeration cycle unit according to claim 15, wherein the partition wall portion includes an accommodation body configured to accommodate only the compressor and the condenser out of the compressor, the condenser, and the evaporator.

18. A vehicular air conditioning device comprising:
the vehicular refrigeration cycle unit according to claim 3;
the vehicle-exterior heat exchanger; and
the vehicle-interior heat exchanger.
